(19) United States
(12) Patent Application Publication
(10) Pub. No.: US 2006/0155394 A1
(43) Pub. Date: Jul. 13, 2006

(54) Method and apparatus for order-preserving clustering of multi-dimensional data

(75) Inventor: Tanveer Syeda-Mahmood, Cupertino, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/013,483

(22) Filed: Dec. 16, 2004

(51) Int. Cl. G05B 11/01

(52) U.S. Cl. 700/20

(57) ABSTRACT

A method of clustering ordered data sets, wherein the method comprises forming n-dimensional curvilinear representations from an ordered data set; formulating a n+1-dimensional curvilinear representation from a pair of ordered data sets; computing a similarity of the pair of ordered data sets using a similarity between the n-dimensional curvilinear representations and the n+1-dimensional curvilinear representation; and clustering ordered data sets based on the similarity between the n-dimensional curvilinear representations and the n+1-dimensional curvilinear representation. In the n-dimensional curvilinear representations, a first dimension of space corresponds with a common ordering dimension and the remaining dimension of space corresponds with the ordered data set. The process of computing the similarity comprises comparing a shape of the n+1-dimensional curvilinear representation to a shape of each component n-dimensional curvilinear representation. In the computing of the similarity, the shape of the n+1-dimensional curvilinear representation corresponds with inflection points on the n+1-dimensional curvilinear representation.

### BACKGROUND OF THE INVENTION

1. Field of the Invention

The embodiments of the invention generally relate to data mining, and more particularly to techniques for managing and ordering multi-dimensional data in a database and data computing environments.

2. Description of the Related Art

In many applications, there is an inherent order in the data. Frequently, such order is given in time; i.e., data that can be modeled as a time series. Clustering of ordered data sets is a problem that occurs frequently in many pattern recognition tasks. Examples include gene expression data as a function of time, system tables of a database changing over time, message queues changing over time, etc. For example, clustering groups of genes or samples by analyzing their varied patterns with respect to time, dosage, patient age, etc. reveals more information about functionally similar genes than is possible with the clustering of their intensity values alone.

However, the order of this data is not always time dependent. Examples include patient data sampled in various states, experimental conditions, etc. Existing ways of clustering ordered data sets are of two main types: (a) those that project each of the ordered sets of data as a point in multi-dimensional space and use a distance metric such as the Euclidean distance to measure similarity, thereby losing the order so that a permutation of data points along the ordering dimension will not materially affect the distance, or (b) use of a restrictive parametric modeling method that makes assumptions about the specifics of the order of the data.

Examples of the former include traditional clustering approaches of machine learning including K-means, hierarchical clustering, neural clustering, Self-Organizing Maps (SOMs), Expectation Maximization (EM)-based clustering methodologies, Gaussian mixture models, and graph-theoretic models, etc.

Examples of the parametric modeling include Hidden Markov Models (HMM), autoregressive (AR) models, autoregressive moving average (ARMA) models, etc. where explicit assumptions are made about the nature of the variation in the ordering dimension (e.g. as a first-order Markov process for HMM). Further, such techniques do not give perceptually meaningful clusters since the approximation to the ordered set in parametric modeling often captures rough overall statistics, but may not capture the finer nuances of the signal. Moreover, these techniques are primarily suitable for modeling statistical time dependencies, and tend to be less sensitive to precise variations in the pattern of expression, leading to clusters that are not very compact.

Thus, existing techniques tend to generally either fail to capture the order present in the data during clustering, or tend to generally use restrictive data models, which make restrictive assumptions in the variations to enable parametric characterization and lose some of the precision details. FIGS. 1 and 2 show ordered sets that are incorrectly clustered using conventional approaches. In FIG. 1, four ordered data sets belonging to a single cluster are shown. The four different datasets have the same sets of values, but are in a different order. They are indistinguishable by a clustering approach that projects the ordered set as a point in multi-dimensional space. Similarly, FIG. 2 shows a sample cluster produced by a conventional modeling approach. As can be seen, the resulting cluster produced by the conventional modeling approach is not very discriminatory. FIG. 3 shows a representative cluster using AR modeling where the lack of compactness is apparent. In the general case, when the measurement dimension is discrete, as in the case of patient samples, explicit dependency modeling may not even be possible.

Therefore, due to the challenges facing conventional clustering techniques, there remains a need for a novel technique capable of clustering multi-dimensional data without making restrictive and unpractical assumptions as to their modeling and calculations, and which are capable of capturing the order of the data during clustering.

### SUMMARY OF THE INVENTION

In view of the foregoing, an embodiment of the invention provides a method of clustering ordered data sets and a program storage device of implementing a method of clustering ordered data sets, wherein the method comprises forming two-dimensional curvilinear representations from an ordered data set; formulating a three-dimensional curvilinear representation from a pair of ordered data sets; computing a similarity of the pair of ordered data sets using a similarity between the two-dimensional curvilinear representations and the three-dimensional curvilinear representation; and clustering ordered data sets based on the similarity between the two-dimensional curvilinear representations and the three-dimensional curvilinear representation. In the two-dimensional curvilinear representations, a first dimension of space corresponds with a common ordering dimension and a second dimension of space corresponds with the ordered data set.

The process of computing the similarity comprises comparing a shape of the three-dimensional curvilinear representation to a shape of each component two-dimensional curvilinear representation. Moreover, in the computing of the similarity, the shape of the three-dimensional curvilinear representation corresponds with inflection points on the three-dimensional curvilinear representation. Furthermore, in the computing of the similarity, the inflection points are identified using scale-space analysis. Additionally, in the computing of the similarity, the scale-space analysis comprises computing a distance between the two-dimensional curvilinear representations and the three-dimensional curvilinear representation, wherein the distance comprises a location and strength of the inflection points and a distance between corresponding inflection points.

The clustering process comprises selecting initial two-dimensional curvilinear representations as prototypes for clusters; classifying non-selected two-dimensional curvilinear representations as belonging to the cluster represented by at least one of the prototypes; and recomputing the prototypes based on the selected and non-selected two-dimensional curvilinear representations. Also, the classifying process and the recomputing process are repeated until there is convergence between the classification of the two-dimensional curvilinear representations and the recomputing of the prototypes.

Another embodiment of the invention provides a method of clustering ordered data sets, wherein the method comprises forming n-dimensional curvilinear representations from an ordered data set; formulating a n+1-dimensional curvilinear representation from a pair of ordered data sets; computing a similarity of the pair of ordered data sets using a similarity between the n-dimensional curvilinear representations and the n+1-dimensional curvilinear representation; and clustering ordered data sets based on the similarity between the n-dimensional curvilinear representations and the n+1-dimensional curvilinear representation. In the n-dimensional curvilinear representations, a first dimension of space corresponds with a common ordering dimension and the remaining dimension of space corresponds with the ordered data set.

The process of computing the similarity comprises comparing a shape of the n+1-dimensional curvilinear representation to a shape of each component n-dimensional curvilinear representation. In the computing of the similarity, the shape of the n+1-dimensional curvilinear representation corresponds with inflection points on the n+1-dimensional curvilinear representation. In the computing of the similarity, the inflection points are identified using scale-space analysis. In the computing of the similarity, the scale-space analysis comprises computing a distance between the n-dimensional curvilinear representations and the n+1-dimensional curvilinear representation, wherein the distance comprises a location and strength of the inflection points and a distance between corresponding inflection points.

The clustering process comprises selecting initial n-dimensional curvilinear representations as prototypes for clusters; classifying non-selected n-dimensional curvilinear representations as belonging to the cluster represented by at least one of the prototypes; and recomputing the prototypes based on the selected and non-selected n-dimensional curvilinear representations. Additionally, the classifying process and the recomputing process are repeated until there is convergence between the classification of the n-dimensional curvilinear representations and the recomputing of the prototypes.

Generally, the embodiments of the invention provide a novel approach to clustering ordered sets of data by regarding them as curve shapes. Using individual curves, a new multi-dimensional space can be formed in which each of the dimensions represents one of the ordered sets. Then, the resulting shape remains a multi-dimensional curve. By projecting, pairwise, two ordered data sets at a time, three dimensional curves can be formed. If the individual curves are similar, their multi-dimensional curve preserves their shape. However, if the individual curves being compared are quite dissimilar, this is reflected in the additional “twists and turns” (i.e., additional non-linearity) produced in the multi-dimensional curve that is directly a result of the mismatch of the shapes at the corresponding position in the order. In particular, the number of additional “twists and turns” (i.e., additional non-linearity) in comparison to the original “twists and turns” (i.e., original non-linearity) in the original curves can serve as a measure of the similarity between the two data sets. The clustering technique provided by the embodiments of the invention may be implemented in several environments such as stock market forecasting, genomics, autonomic computing (i.e., self-diagnosis through data mining), as well as several other environments.

The embodiments of the invention generally provide a new pattern recognition-based method for order-preserving clustering. The scale-space distance has been shown to be effective in capturing shape similarity in curves thus giving rise to perceptually meaningful clusters while still preserving the order in the dataset.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a graphical representation illustrating of ordered sets of data incorrectly clustered using conventional clustering approaches;

FIG. 2 is a graphical representation illustrating a sample cluster produced by conventional clustering approaches;

FIG. 3 is a graphical representation illustrating a sample cluster represented by curves produced by conventional clustering approaches;

FIGS. 4(A) through 4(D) are graphical representations illustrating the measurement of shape dissimilarity according to an embodiment of the invention;

FIG. 5(A) is a graphical representation illustrating a time-varying gene profile according to an embodiment of the invention;

FIG. 5(B) is a graphical representation illustrating the scale-space representation of FIG. 5(A) using Gaussian filters according to an embodiment of the invention;

FIG. 5(C) is a graphical representation of a scale-space signal of FIG. 5(A) according to an embodiment of the invention;

FIG. 6 is a flow diagram illustrating a preferred method according to an embodiment of the invention;

FIGS. 7(A) through 7(C) are graphical representations illustrating time-varying profiles of genes in a cluster according to an embodiment of the invention;

FIG. 8 is a tabular representation illustrating clustering using scale-space analysis and Euclidean distance according to an embodiment of the invention;

FIG. 9 is a tabular representation illustrating the accuracy of clustering using scale-space distance according to the embodiments of the invention; and

FIG. 10 is a computer system diagram according to an embodiment of the invention.

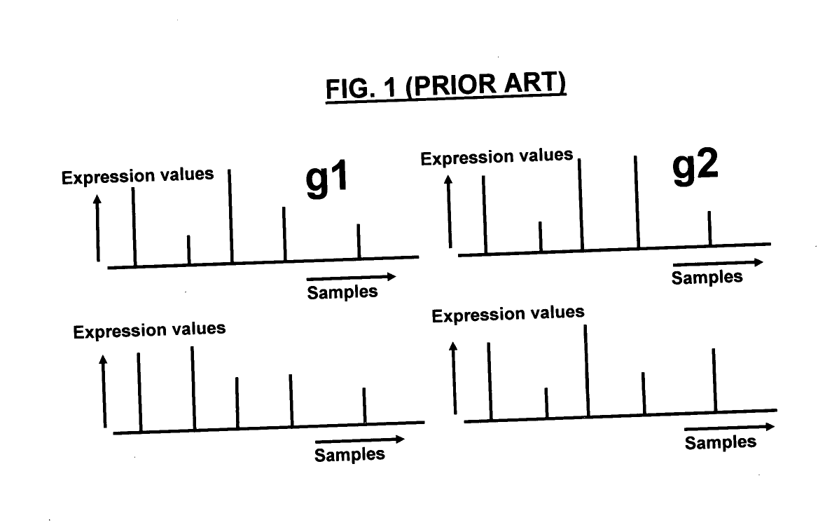

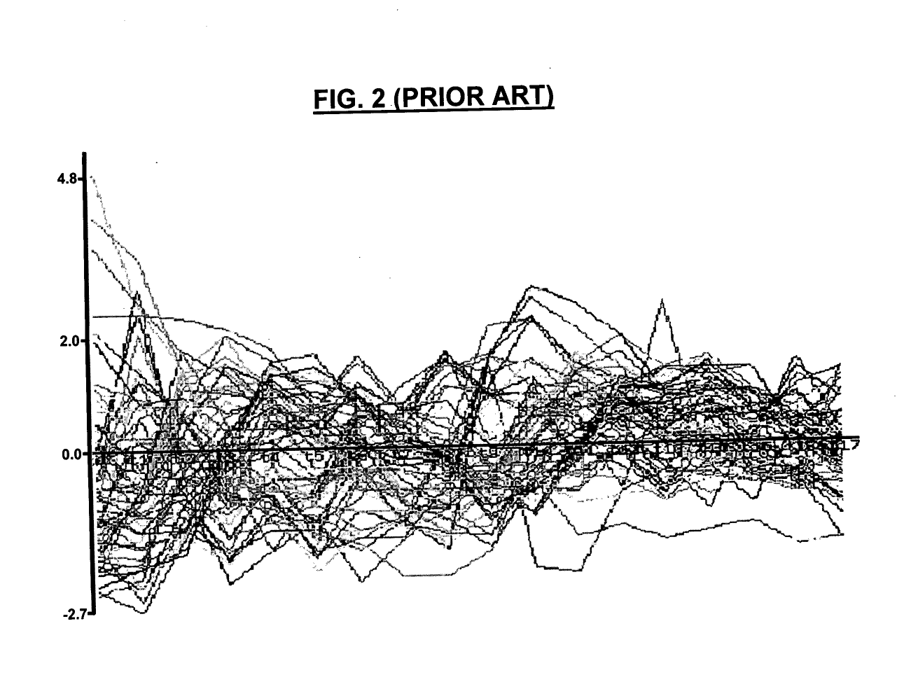

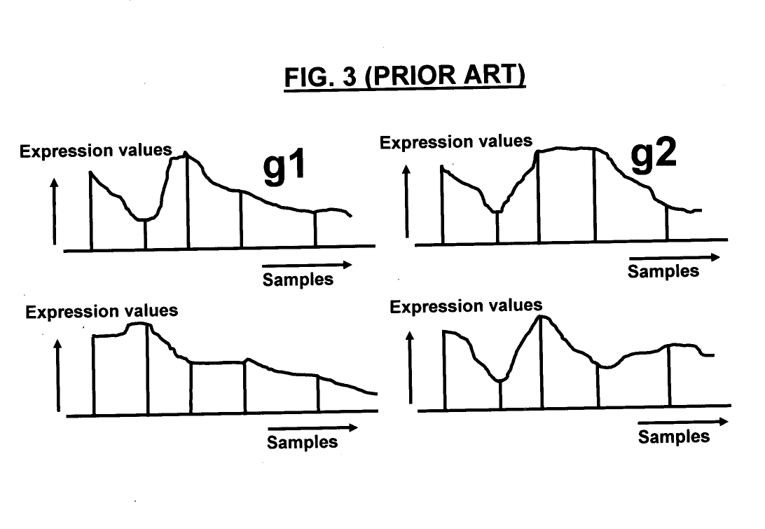

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

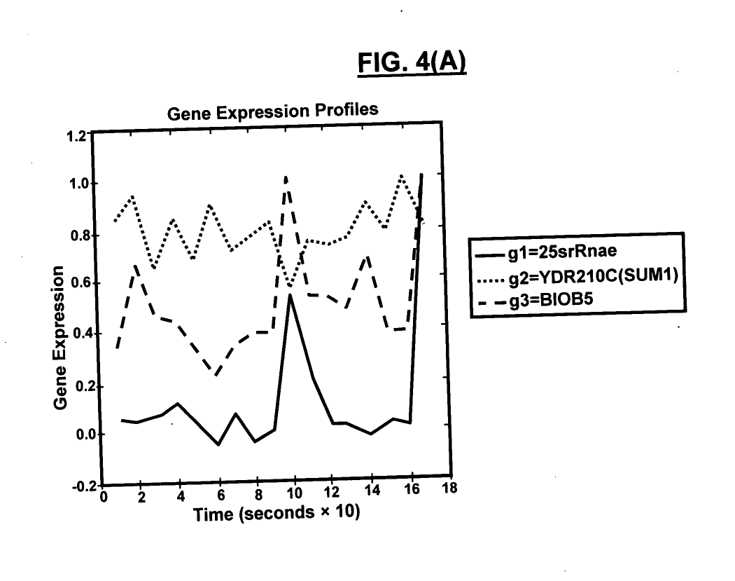

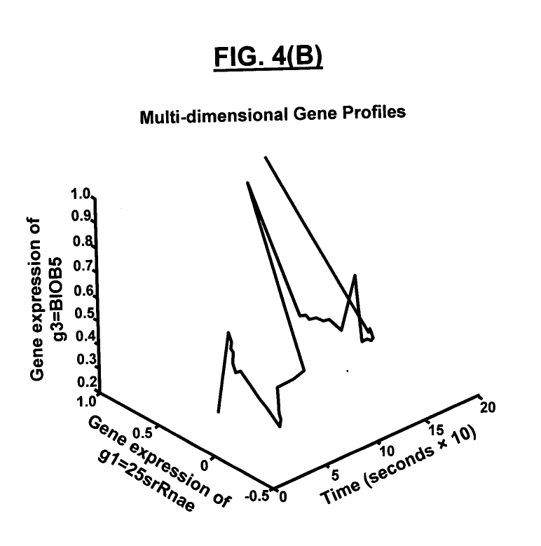

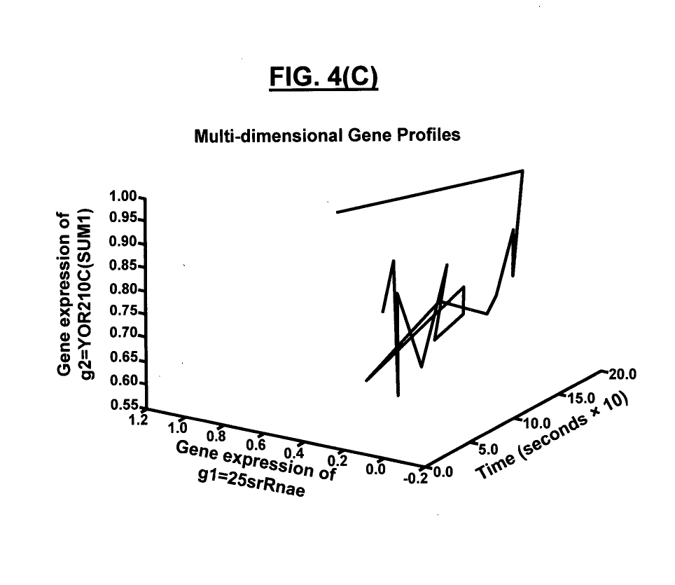

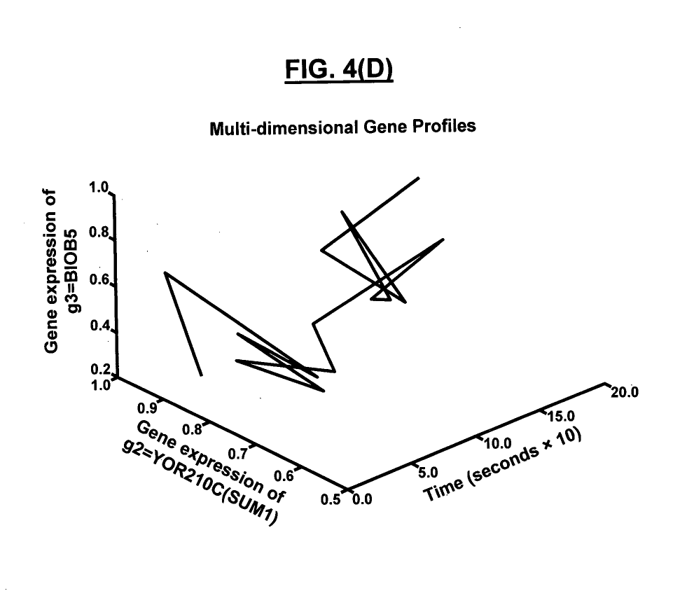

As mentioned, there remains a need for a novel technique capable of clustering multi-dimensional data without making restricting and unpractical assumptions as to their modeling and calculations, and which are capable of capturing the order of the data during clustering. The embodiments of the invention address these needs by providing a general order-preserving clustering methodology that allows arbitrary patterns of data evolution by representing each ordered set as a curve. Clustering of the data then reduces to grouping curves based on shape similarity. Then, the embodiments of the invention provide a novel measure of shape similarity between curves using scale-space distance. Shape similarity or dissimilarity is judged by composing higher dimensional curves from constituent curves and noting the additional twists and turns in such curves that can be attributed to shape differences. Thereafter, the embodiments of the invention provide a methodology analogous to K-means clustering that uses prototypical curves for representing the clusters. Referring now to the drawings and more particularly to FIGS. 4 through 10 where similar reference characters denote corresponding features consistently throughout the figures, there are shown preferred embodiments of the invention.

Given two two-dimensional curves (g1(t), t) and (g2(t), t), then (G(t), t)=(g1(t), g2(t), t) can be modeled as a three-dimensional curve formed by projecting the two curves in three-dimensional space (g1, g2, t). If g1 and g2 are similar in shape, then the three-dimensional curve is similar in shape to the individual constituent curves. However, if g1 and g2 differ in shape, then the three-dimensional curve depicts relatively large amounts of sharp twists, bends and turns over and above the changes present in the component curves. Furthermore, these changes occur precisely at points where the pattern differs in the constituent curves, thus preserving inherently the order present in the variational pattern.

FIGS. 4(A) through 4(D) illustrate three-dimensional curves formed from pairs of variational patterns shown in FIG. 4(A). As can be seen, when the component curves are similar (for open reading frames (ORFs) 18srRnaa and 18srRnac), their corresponding three-dimensional curve (FIG. 4B)) shows similar changes as in the original curves. On the other hand, when two dissimilar signals are composed (18srRnaa and 18srRnab) as in FIG. 4(C) or profiles 18srRnab and 18srRnac as shown in FIG. 4(D), the sharp bends and twists are apparent in the three-dimensional curve. In fact, the sharpness of turn is proportional to the mismatch between the two component curves from which the three-dimensional curve is derived. Thus, by comparing the sharpness of bends in the three-dimensional curve to the underlying shape of the component curves at corresponding points, a measure of similarity can be obtained between the two curves. This scheme can be generalized for comparing multiple curves simultaneously by projecting n constituent curves into an n+1-dimensional space and forming an n+1-dimensional curve.

The shape similarity measure captures sharp changes in the projected higher-dimensional curve and the associated constituent curves. Change points on curves are inflection points; i.e., places where there are zero-crossings of the second derivative. Salient change points are those that are perceptually important; i.e., changes that are preserved even after multiple levels of smoothing. To detect the salient changes, a scale-space analysis is used. Specifically, a continuous representation is formed by successively smoothing a curve C(t) (projected or constituent) using a kernel (Gaussian kernel used) g(t, σ), which provides:

$$\hat{C} ( t , σ ) = C ( t ) * g ( t , σ ) = {\int }_{- ∞}^{∞} C ( u ) \frac{1}{σ \sqrt{2 π}} {ⅇ}^{- \frac{{( t - u )}^{2}}{2 σ}} ⅆ u \qquad ( 1 )$$

wherein * represents a convolution integral operation. The inflection points are locations of the zero-crossing of the second derivative; i.e., where

$$\frac{{\partial }^{2} \hat{C}}{\partial {t}^{2}} = 0 \qquad ( 2 )$$

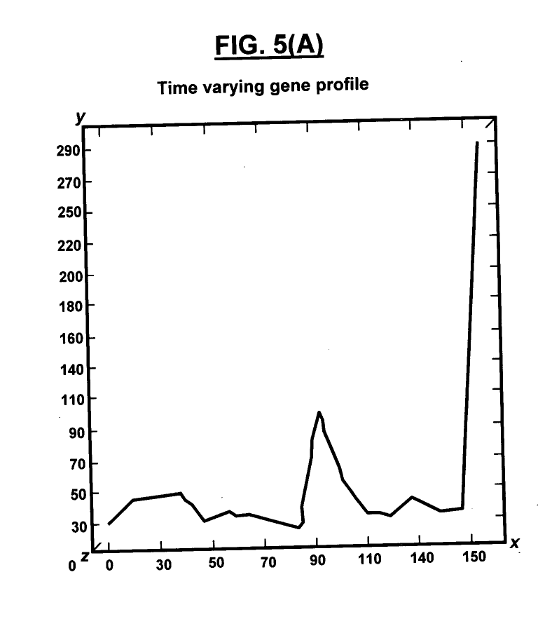

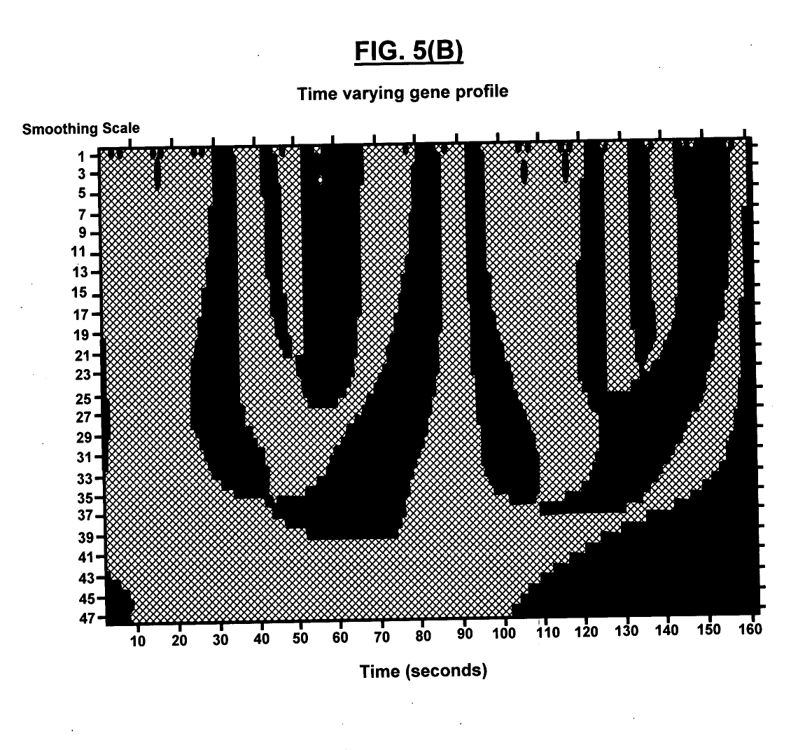

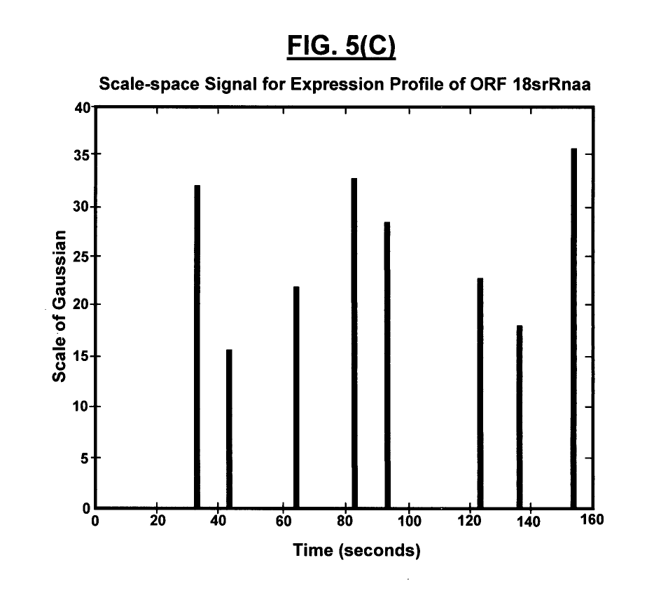

For multi-dimensional curves, formula (1) reduces to making the determinant of the Hessian to be zero. The original inflection points can then be recovered from negative-going zero-crossings of the second derivative. Thus, if places on the curve are viewed where there is a change of sign in the second derivative of the signal as a function of scale, then the resulting two-dimensional image looks as shown in FIG. 5(B). Here, the zero-crossing contours are the contours of the cross-hatched and black regions in FIG. 5(B). In particular, the negative-going zero-crossings are the contours of the cross-hatched to black transition regions. In particular, it can be shown that in the case of Gaussian smoothing, the zero-crossing contours are always closed at the bottom (higher scale) and open at the top (U-shaped curves). Also, the zero-crossings shift with increasing scale, so that the exact location of a zero-crossing is found by starting from the peak of a contour and tracking the contour down to its finest scale location. The resulting representation is called the scale-space signal, and describes the location of sharp change points in the curve. In particular, the intensity at a point in a scale-space signal is the highest scale at which the change disappears. Thus, sharper changes are reflected as high intensity points in the curve. FIG. 5(C) shows the scale-space signal for the original curve in FIG. 5(A).

Using the scale-space signals, the distance between two curves g1(t) and g2(t) is given by the following scale-space distance:

$$D ( g 1 , g 2 ) = {\sum }_{i = 1}^{T} {( {I}_{C} ( i ) - \frac{( {I}_{1} ( i ) + {I}_{2} ( i ) )}{2} )}^{2} \qquad ( 3 )$$

where I_{C}(i), I₁(i), I₂(i) are the scale-space signals of the individual and combined curves respectively. This similarity measure remains a metric, since it can be interpreted as the Euclidean distance between the transformed curves in scale-space. Since the scale-space curves for multi-dimensional curves are also one-dimensional, the above distance metric can be used to compute the similarity between multi-dimensional curves and one-dimensional curves, two multi-dimensional curves, etc. This shall prove useful in clustering the curves as discussed below.

Once a shape matching distance metric is chosen, it can be used to substitute a distance metric used in any clustering algorithm to obtain various clustering schemes using curve shapes. The approach described herein focuses on adapting the K-means clustering because, while K-means clustering is a relatively older methodology, the clusters produced have some desirable properties if proper initialization can be insured and fast convergence can be obtained. Analogous to the concept of centroids, a mean shape is used; i.e., a multi-dimensional curve formed from the individual curves in the group to serve as a prototype for the cluster.

Following the K-means methodology, the clustering in performed using three steps: (1) initial prototype selection, (2) classification of curves, and (3) recomputation of the prototypes. Steps 2 and 3 are repeated until convergence is reached (when the prototypes do not change much). Different methods of initial selection of the centroids can be used. Here, the maximum scale-space distance is used between a randomly selected curve and all other curves to assemble initial cluster prototypes. That is, K curves whose distance to one another attribute is greater than 0.9 times the maximum scale-space distance are retained as the initial K prototypes. In the classification step, the minimum scale-space distance between a curve and all K prototypes is used to assign a curve to the corresponding cluster. The multi-dimensional curve formed from the curves in a cluster becomes the new prototype for the next iteration. The complexity of the methodology remains O(nK) for initialization of K prototypes for the n-element dataset, and O(mnK) for m iterations of data classification and O(mn) for recomputation of prototypes.

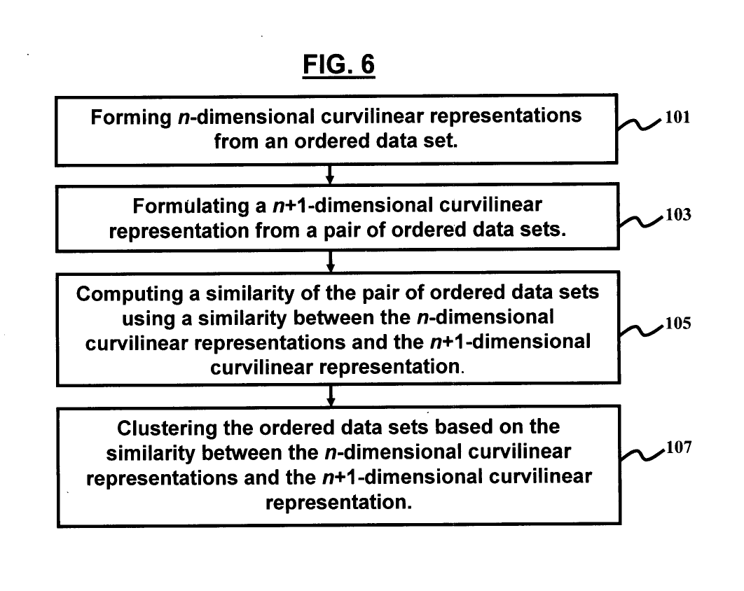

FIG. 6 illustrates a flow diagram of a methodology according to an embodiment of the invention. Specifically, FIG. 6 illustrates a method of clustering ordered data sets, wherein the method comprises forming (101) n-dimensional curvilinear representations from an ordered data set (n being a positive integer); formulating (103) a n+1-dimensional curvilinear representation from a pair of ordered data sets; computing (105) a similarity of the pair of ordered data sets using a similarity between the n-dimensional curvilinear representations and the n+1-dimensional curvilinear representation; and clustering (107) ordered data sets based on the similarity between the n-dimensional curvilinear representations and the n+1-dimensional curvilinear representation.

In the n-dimensional curvilinear representations, a first dimension of space corresponds with a common ordering dimension and the remaining dimension of space corresponds with the ordered data set. The process of computing (105) the similarity comprises comparing a shape of the n+1-dimensional curvilinear representation to a shape of each component n-dimensional curvilinear representation. In the computing (105) of the similarity, the shape of the n+1-dimensional curvilinear representation corresponds with inflection points on the n+1-dimensional curvilinear representation. In the computing (105) of the similarity, the inflection points are identified using scale-space analysis. In the computing of the similarity, the scale-space analysis comprises computing a distance between the n-dimensional curvilinear representations and the n+1-dimensional curvilinear representation, wherein the distance comprises a location and strength of the inflection points and a distance between corresponding inflection points.

The clustering process (107) comprises selecting initial n-dimensional curvilinear representations as prototypes for clusters; classifying non-selected n-dimensional curvilinear representations as belonging to the cluster represented by at least one of the prototypes; and recomputing the prototypes based on the selected and non-selected n-dimensional curvilinear representations. Additionally, the classifying process and the recomputing process are repeated until there is convergence between the classification of the n-dimensional curvilinear representations and the recomputing of the prototypes.

The above-described methodology for order-preserving clustering was experimentally applied to the problem of clustering gene expression profiles to determine functionally similar genes. The data for clustering is derived from gene chips that record the expression of genes under several conditions and present it as a two-dimensional array of data where the rows represent genes and columns represent experimental conditions, samples, time, etc. Given a database of gene curves, the scale-space signals are derived for each of the curves. Scale-space signals of higher-dimensional curves are formed during the iteration steps of clustering as cluster prototypes are assembled. The result is an indexed database with the prototype curves per cluster serving as indexes. Given a new gene curve as a query, the methodology provided by the embodiments of the invention retrieves matching prototypes from clusters and lists the constituent genes in a cluster along with links to their associated information in a public database to allow scientists to infer functional similarity of a newly discovered gene.

The results of illustrating the utility of modeling curves as shapes in clustering gene expression data is provided below. The database used for experiments comprises cell cycle data recording the expression of 6600 ORFs (some of which are genes) in the yeast genome. This depicts expression of genes against 17 experimental conditions (in this case, 17 time points). Modeling expression patterns as curves can also handle this case where the dependency between samples is based on time. This data set is chosen as it has ground truth clusters defined where the clusters correspond to genes that are regulated by the same phase of the cell cycle.

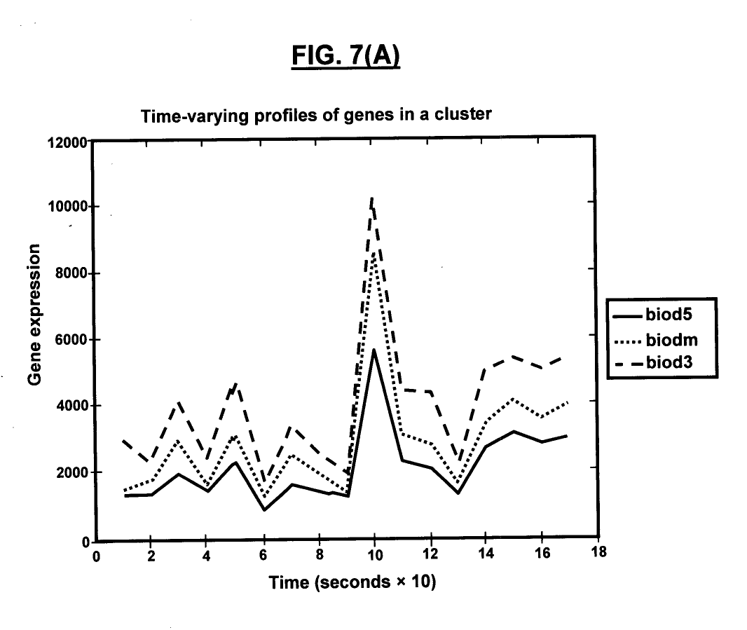

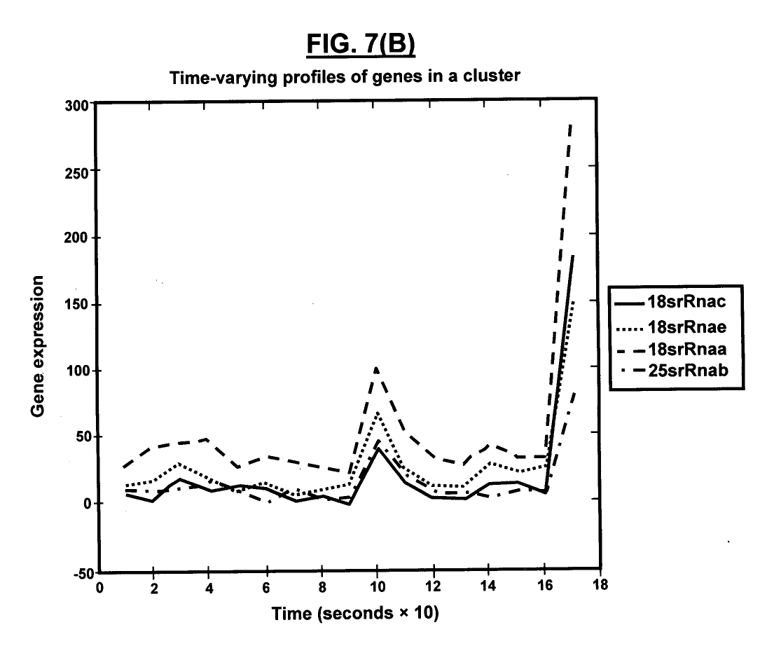

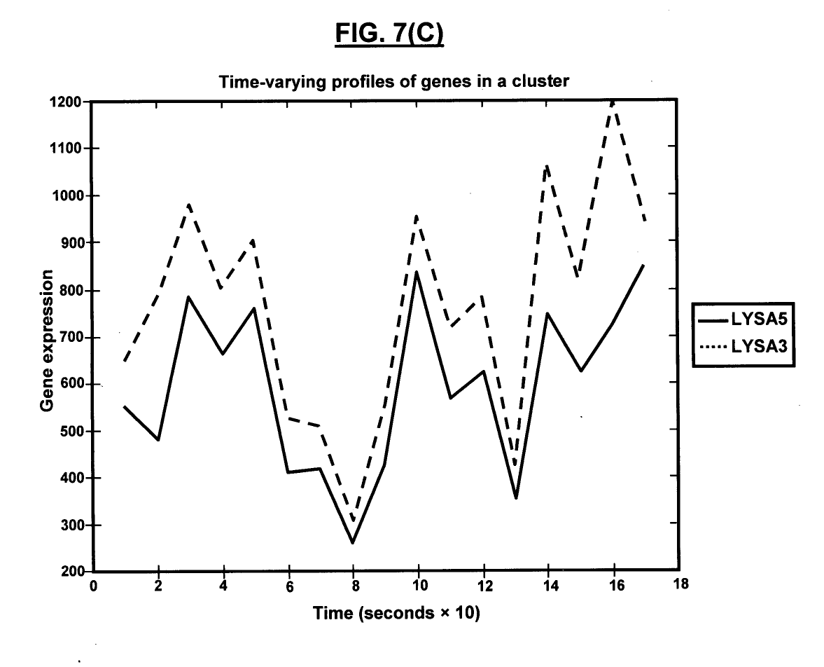

First, the nature of clusters formed using the scale-space distance metric is illustrated. FIGS. 7(A) through 7(C) show the three clusters obtained from the above data set, depicting a correct grouping of functionally related genes. It can also be seen that the clusters are compact and perceptually meaningful with co-regulation patterns clearly emerging, even though the scale of variation is considerably different within a cluster.

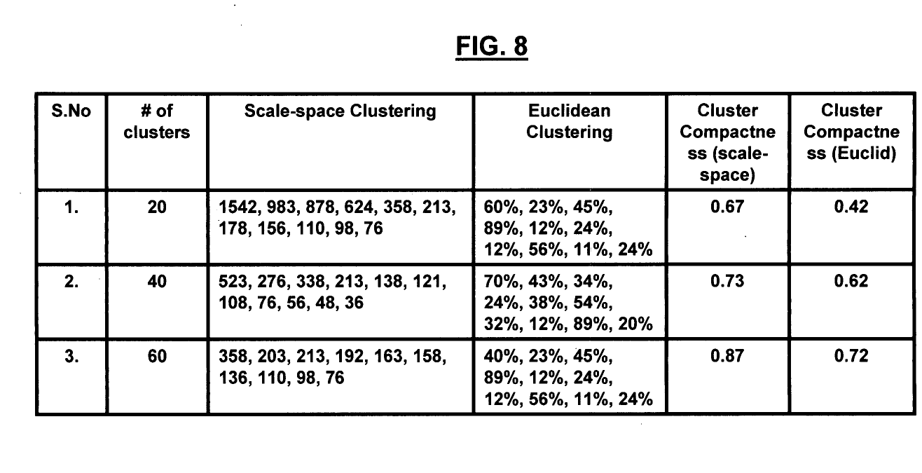

Next, clustering using scale-space distance and Euclidean distance is compared for different choices of the number of clusters. The methodology for initialization of centroids remains the same in both cases, using the farthest distance between a pair of genes as the seed distance for cluster separation. The results are tabulated in the table shown in FIG. 8. Here, column 1 indicates the choice of K, column 2 indicates the number of members in corresponding clusters for the 10 largest clusters, and column 3 indicates the percentage overlap between the corresponding clusters in the Euclidean distance case. The corresponding clusters are based on the highest amount of overlap. From this, it can be inferred that the two methods produce different cluster distributions. Next, in columns 4 and 5, the average intra-cluster compactness for the two cases are listed as the ratio of the average distance to the maximum distance between pairs of curves for the two choices of distance metrics. As expected, the cluster-compactness increases with the number of clusters.

To compare the performance of both metrics for clustering against the ground truth data, the clustering is repeated on a smaller data set comprising 104 cell-cycle regulated genes that have already been manually clustered into functionally similar groups based on biological verification of their cell-cycle co-regulation patterns.

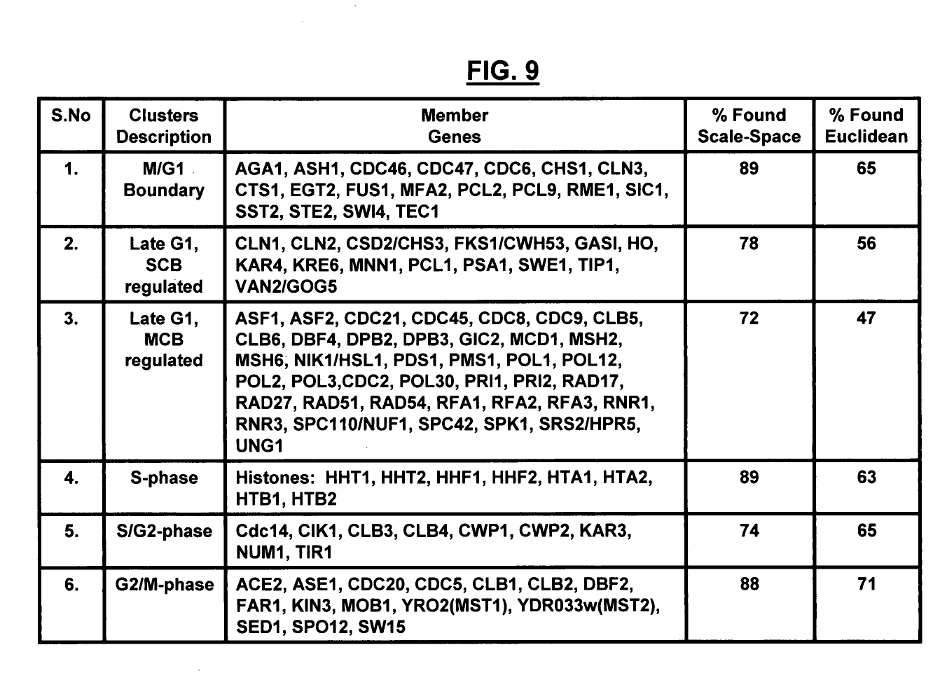

These genes are listed in column 3 of the table provided in FIG. 9. The clustering methodologies are run on the reduced data set comprising 104 genes isolated above. The percentage overlap with the ground truth clusters for the same value of K is recorded for both clustering methods, and is shown in columns 4 and 5 of the table shown in FIG. 9. As can be seen, the scale-space distance-based metric is more effective in grouping genes known to be functionally similar.

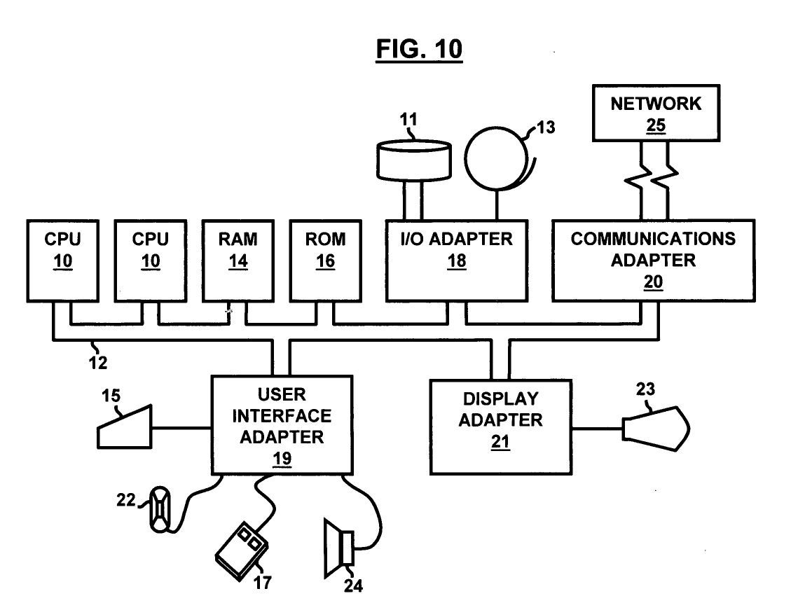

A representative hardware environment for practicing the embodiments of the invention is depicted in FIG. 10. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Generally, the embodiments of the invention provide a novel approach to clustering ordered sets of data by regarding them as curve shapes. Using individual curves, a new multi-dimensional space can be formed in which each of the dimensions represents one of the ordered sets. Then, the resulting shape remains a multi-dimensional curve. By projecting, pairwise, two ordered data sets at a time, three dimensional curves can be formed. If the individual curves are similar, their multi-dimensional curve preserves their shape. However, if the individual curves being compared are quite dissimilar, this is reflected in the additional “twists and turns” (i.e., additional non-linearity) produced in the multi-dimensional curve that is directly a result of the mismatch of the shapes at the corresponding position in the order. In particular, the number of additional “twists and turns” (i.e., additional non-linearity) in comparison to the original “twists and turns” (i.e., original non-linearity) in the original curves can serve as a measure of the similarity between the two data sets. The clustering technique provided by the embodiments of the invention may be implemented in several environments such as stock market forecasting, genomics, autonomic computing (i.e., self-diagnosis through data mining), as well as several other environments.

The embodiments of the invention generally provide a new pattern recognition-based method for order-preserving clustering. The scale-space distance has been shown to be effective in capturing shape similarity in curves thus giving rise to perceptually meaningful clusters while still preserving the order in the dataset.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the embodiments of the invention can be practiced with modification within the spirit and scope of the appended claims.

What is claimed is:

1. A method of clustering ordered data sets, said method comprising:
forming two-dimensional curvilinear representations from an ordered data set;
formulating a three-dimensional curvilinear representation from a pair of ordered data sets;
computing a similarity of said pair of ordered data sets using a similarity between said two-dimensional curvilinear representations and said three-dimensional curvilinear representation; and
clustering ordered data sets based on said similarity between said two-dimensional curvilinear representations and said three-dimensional curvilinear representation.

2. The method of claim 1, wherein in said two-dimensional curvilinear representations, a first dimension of space corresponds with a common ordering dimension and a second dimension of space corresponds with said ordered data set.

3. The method of claim 1, wherein said computing of said similarity comprises comparing a shape of said three-dimensional curvilinear representation to a shape of each component two-dimensional curvilinear representation.

4. The method of claim 3, wherein in said computing of said similarity, said shape of said three-dimensional curvilinear representation corresponds with inflection points on said three-dimensional curvilinear representation.

5. The method of claim 4, wherein in said computing of said similarity, said inflection points are identified using scale-space analysis.

6. The method of claim 5, wherein in said computing of said similarity, said scale-space analysis comprises computing a distance between said two-dimensional curvilinear representations and said three-dimensional curvilinear representation, wherein said distance comprises a location and strength of said inflection points and a distance between corresponding inflection points.

7. The method of claim 1, wherein the clustering process comprises:
selecting initial two-dimensional curvilinear representations as prototypes for clusters;
classifying non-selected two-dimensional curvilinear representations as belonging to said cluster represented by at least one of said prototypes; and
recomputing said prototypes based on said selected and non-selected two-dimensional curvilinear representations.

8. The method of claim 7, wherein the classifying process and the recomputing process are repeated until there is convergence between the classification of said two-dimensional curvilinear representations and the recomputing of the prototypes.

9. A method of clustering ordered data sets, said method comprising:
forming n-dimensional curvilinear representations from an ordered data set;
formulating a n+1-dimensional curvilinear representation from a pair of ordered data sets;
computing a similarity of said pair of ordered data sets using a similarity between said n-dimensional curvilinear representations and said n+1-dimensional curvilinear representation; and
clustering ordered data sets based on said similarity between said n-dimensional curvilinear representations and said n+1-dimensional curvilinear representation.

10. The method of claim 9, wherein in said n-dimensional curvilinear representations, a first dimension of space corresponds with a common ordering dimension and a remaining dimension of space corresponds with said ordered data set.

11. The method of claim 9, wherein said computing of said similarity comprises comparing a shape of said n+1-dimensional curvilinear representation to a shape of each component n-dimensional curvilinear representation.

12. The method of claim 11, wherein in said computing of said similarity, said shape of said n+1-dimensional curvilinear representation corresponds with inflection points on said n+1-dimensional curvilinear representation.

13. The method of claim 12, wherein in said computing of said similarity, said inflection points are identified using scale-space analysis.

14. The method of claim 13, wherein in said computing of said similarity, said scale-space analysis comprises computing a distance between said n-dimensional curvilinear representations and said n+1-dimensional curvilinear representation, wherein said distance comprises a location and strength of said inflection points and a distance between corresponding inflection points.

15. The method of claim 9, wherein the clustering process comprises:
selecting initial n-dimensional curvilinear representations as prototypes for clusters;
classifying non-selected n-dimensional curvilinear representations as belonging to said cluster represented by at least one of said prototypes; and
recomputing said prototypes based on said selected and non-selected n-dimensional curvilinear representations.

16. The method of claim 15, wherein the classifying process and the recomputing process are repeated until there is convergence between the classification of said n-dimensional curvilinear representations and the recomputing of the prototypes.

17. A program storage device readable by computer, tangibly embodying a program of instructions executable by said computer to perform a method of clustering ordered data sets, said method comprising:
forming two-dimensional curvilinear representations from an ordered data set;
formulating a three-dimensional curvilinear representation from a pair of ordered data sets;
computing a similarity of said pair of ordered data sets using a similarity between said two-dimensional curvilinear representations and said three-dimensional curvilinear representation; and
clustering ordered data sets based on said similarity between said two-dimensional curvilinear representations and said three-dimensional curvilinear representation.

18. The program storage device of claim 17, wherein in said two-dimensional curvilinear representations, a first dimension of space corresponds with a common ordering dimension and a second dimension of space corresponds with said ordered data set.

19. The program storage device of claim 17, wherein said computing of said similarity comprises comparing a shape of said three-dimensional curvilinear representation to a shape of each component two-dimensional curvilinear representation.

20. The program storage device of claim 19, wherein in said computing of said similarity, said shape of said three-dimensional curvilinear representation corresponds with inflection points on said three-dimensional curvilinear representation.

21. The program storage device of claim 20, wherein in said computing of said similarity, said inflection points are identified using scale-space analysis.

22. The program storage device of claim 21, wherein in said computing of said similarity, said scale-space analysis comprises computing a distance between said two-dimensional curvilinear representations and said three-dimensional curvilinear representation, wherein said distance comprises a location and strength of said inflection points and a distance between corresponding inflection points.

23. The program storage device of claim 17, wherein the clustering process comprises:
selecting initial two-dimensional curvilinear representations as prototypes for clusters;
classifying non-selected two-dimensional curvilinear representations as belonging to said cluster represented by at least one of said prototypes; and
recomputing said prototypes based on said selected and non-selected two-dimensional curvilinear representations.

24. The program storage device of claim 23, wherein the classifying process and the recomputing process are repeated until there is convergence between the classification of said two-dimensional curvilinear representations and the recomputing of the prototypes.
